(19) United States
(12) Patent Application Publication
(10) Pub. No.: US 2026/0204945 A1
(43) Pub. Date: Jul. 16, 2026

(54) SUBSEA SWITCHING DEVICE

(71) Applicant: Siemens Energy AS, Oslo (NO)

(72) Inventors: Endre Brekke, Trondheim (NO); Espen Fredriksen, Trondheim (NO); Karstein Berge Kristiansen, Trondheim (NO)

(21) Appl. No.: 19/133,266

(22) PCT Filed: Jan. 4, 2023
(86) PCT No.: PCT/US2023/010090

§ 371 Date: May 28, 2025

(51) Int. Cl. H02J 13/13; H02J 13/12; H02J 13/333; H02J 13/36; H02J 105/50; H02J 107/105

(52) U.S. Cl. CPC H02J 13/1315; H02J 13/12; H02J 13/333; H02J 13/36; H02J 2105/51; H02J 2107/105

(57) ABSTRACT

A subsea switching device comprises a common load power input (22), a local power supply input (24), a plurality of load power outputs (29) and a switching unit (30). The switching unit comprises a plurality of switches (33), whereby the common load power input (22) may be switched between one or more of the plurality of load power outputs (29). The switching unit (30) further comprises voltage sensors (70) at each load power output, or current sensors (63, 67) or power sensors in each power switch (33) and a subsea control unit. The control unit (27, 60) is adapted to receive an output from one or more of the sensors, to compare the received output value from each sensor with a predetermined threshold value or range, and to switch the power switch of a load power output off, in the event that the received output value falls outside a permitted tolerance of the threshold value or range.

This invention relates to a switching device for subsea, or underwater, use.

Subsea installations or loads in greenfield subsea systems conventionally receive power and control signals from a topside system through parallel subsea cables. Optical fibres may provide control signals, as a primary communication route and electrically conducting cables supply the power. As a back-up, communication signals may be modulated or otherwise superimposed onto electricity supply cables. Each power cable from topside is typically connected to between two and four loads, to limit the impact in the event of a short circuit fault on one of the loads, which requires all of the loads to be shut down because the fault will propagate through the local connections between the loads.

Improvements to such systems are desired.

In accordance with a first aspect of the present invention, a subsea switching device comprises a common load power input, a local power supply input, a plurality of load power outputs and a switching unit; wherein the switching unit comprises a plurality of switches whereby the common load power input may be switched between one or more of the plurality of load power outputs; wherein the switching unit further comprises voltage sensors at each load power output, or current sensors or power sensors in each power switch; and at least one subsea control unit; wherein the or each control unit is adapted to receive an output from one or more of the sensors, to compare the received output value from each sensor with a predetermined threshold value or range, and to switch the power switch of a load power output off, in the event that the received output value falls outside a permitted tolerance of the threshold value or range.

The control device is adapted to be able to switch off power to a load if an under or over voltage, or value of current or power outside the permitted range or levels is detected at the associated output of the switch of the subsea switching unit, or if a specific command to shut down power to the loads is received, adding safety functionality to the subsea switching device. Opening the switches prevents transmission of the power and of its associated communication signal to the load.

In accordance with a second aspect of the present invention, a subsea power and communication system, the system comprising a topside power source, a topside data source, a modulator adapted to modulate a data signal from the data source onto a power signal from the power source; a combined power and data cable, whereby the modulated power and data signal is transmitted on the combined cable; a subsea switching device according to any preceding claim to receive power and data inputs through the combined cable; and a plurality of subsea loads; wherein the switching unit is adapted to switch a power output and a data output to each of the plurality subsea loads independently.

A single cable pair may be used to supply power and communications to multiple subsea loads, without the conventional constraints on numbers of loads due to the risk of all loads shutting down in the event of a single fault.

The subsea switching unit is able to disconnect only faulty loads and continue supply of power and data to remaining loads. Data is modulated onto the power signal topside and then passes through the system unchanged to reach each of the loads. The communications to the loads output the same data from the switch unit as is input at the data input.

The modulation may comprise one of frequency, phase or amplitude modulation.

The system may further comprise a subsea power splitter on the cable between the topside combiner and the subsea switching unit and a local subsea power supply unit, whereby topside power may be supplied through the power splitter to the local subsea supply unit for the subsea switching unit.

The local subsea supply unit may further comprise a transformer or converter to supply AC or DC power respectively, to the subsea switching unit.

The subsea switching unit may comprise at least eight outputs to subsea loads.

The system may further comprise output current detectors at the outputs of the subsea switching unit.

Measurements of output current, or differential current allow the safety control unit to determine an over current, or a short circuit and switch off power to the load on that output.

The control unit may be adapted to receive an output from each current detector or voltage detector, to compare the received output current or voltage value from each detector with a predetermined threshold value or range, and to switch the power switch of a load power output off, in the event that the received current output value falls outside a permitted tolerance of the threshold value or range.

In accordance with a second aspect of the present invention, a method of operating a subsea power and communication system according to the first aspect, comprises supplying a power signal from a topside power source; supplying a data signal from a topside data source; combining the power signal and the data signal to generate a combined signal; supplying the combined signal to a subsea switching device; generating a local power supply in the subsea switching device extracted from the power signal of the combined signal; extracting and inputting to the switching unit, a power element from the combined signal; extracting and inputting to the switching unit, a communications element of the combined signal; splitting the power and communications elements into load specific power and communications signals; inputting the load specific signals at an input to each switch associated with each load; detecting current or voltage levels at each load specific output; determining in the subsea control unit whether the detected current or voltage levels fall outside a permitted range or threshold; if not, continuing to supply the load specific power and communications signals to the load; if outside, then withholding power supply from the relevant switch to terminate transmission of the power and communications signal to that load.

The method may further comprise modulating information onto the relevant communication signal and providing status information for each load and each of the relevant switches to a topside or remote central control

An example of a subsea switching device and associated method of operation in accordance with the present invention will now be described with reference to the accompanying drawings in which:

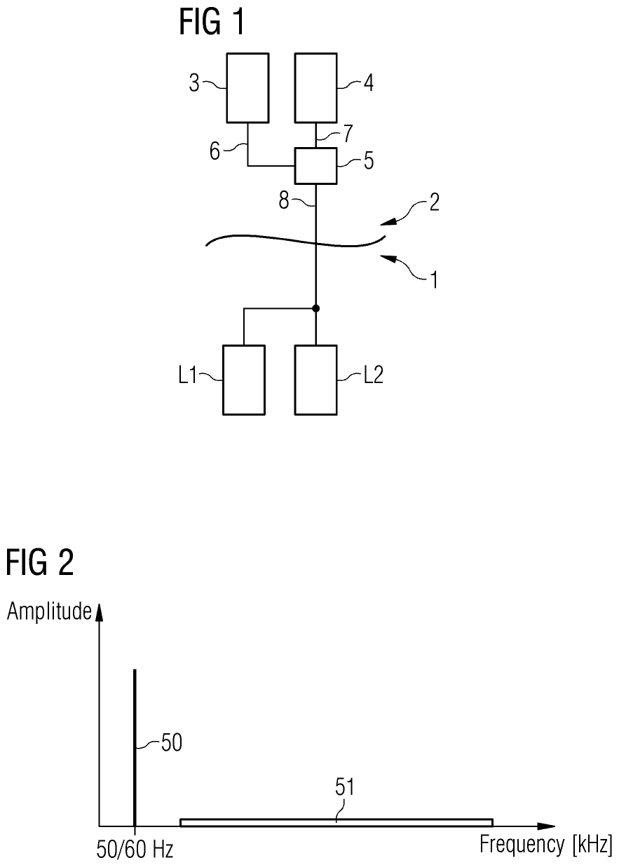

FIG. 1 illustrates an example of subsea system in which the present invention may be used;

FIG. 2 illustrates how power and communications may be combined for use in a subsea system using a switching device according to the present invention;

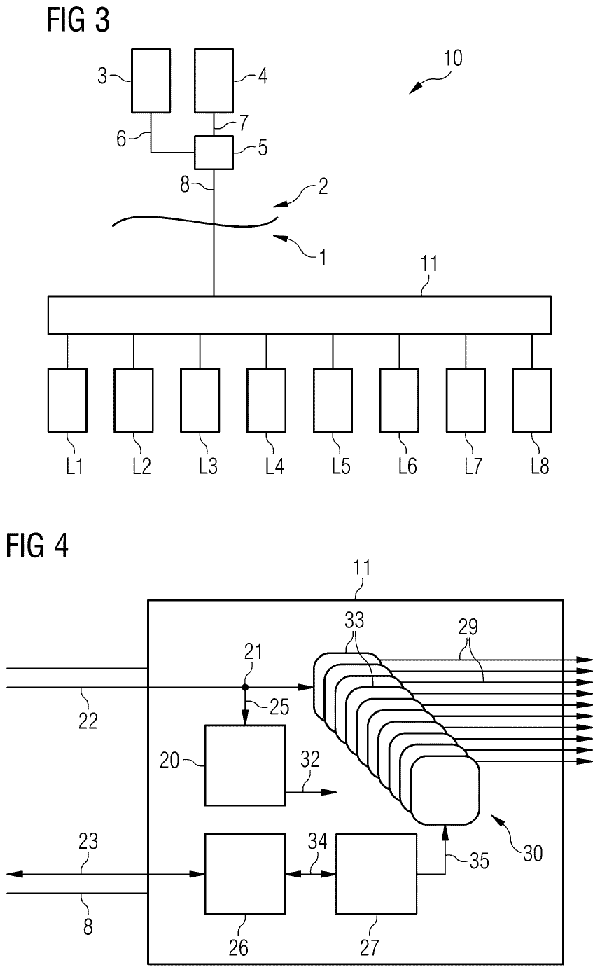

FIG. 3 an example of a subsea system including a subsea switching device according to the present invention;

FIG. 4 illustrates more detail of a subsea switching device according to the present invention, for use in the system of FIG. 3;

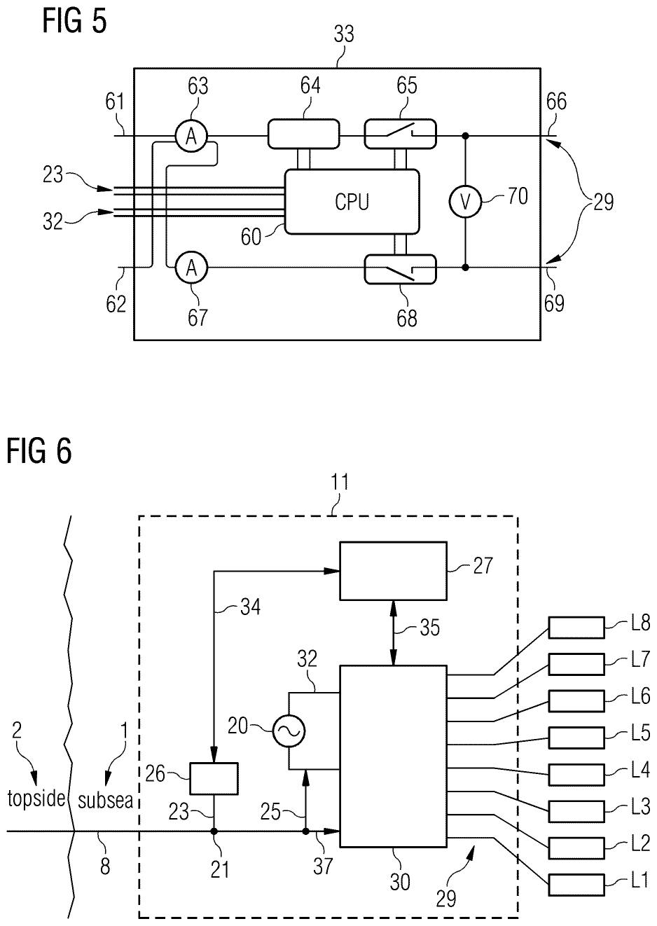

FIG. 5 illustrates more detail of a switch of the switching unit of FIG. 4

FIG. 6 is a block diagram further illustrating an example of the subsea system of FIG. 3 including a subsea switching device according to the present invention;

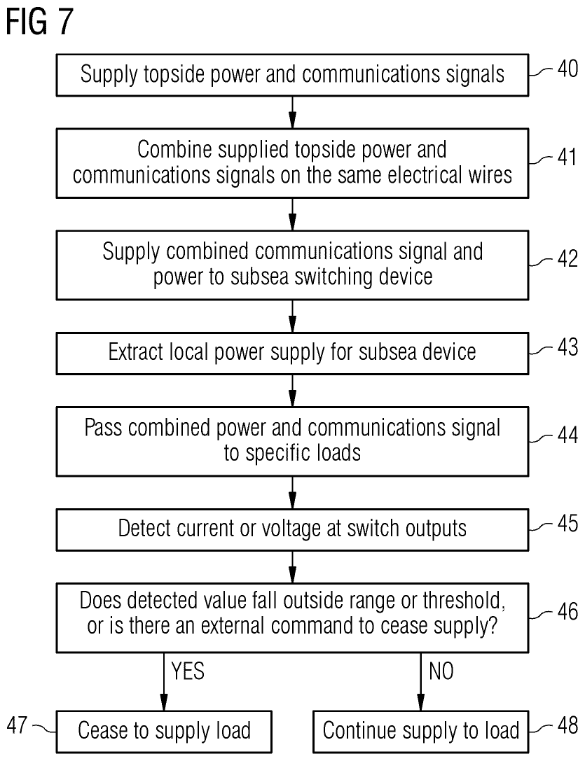

FIG. 7 is a flow diagram of a method of operating a subsea switching system and device according to the present invention;

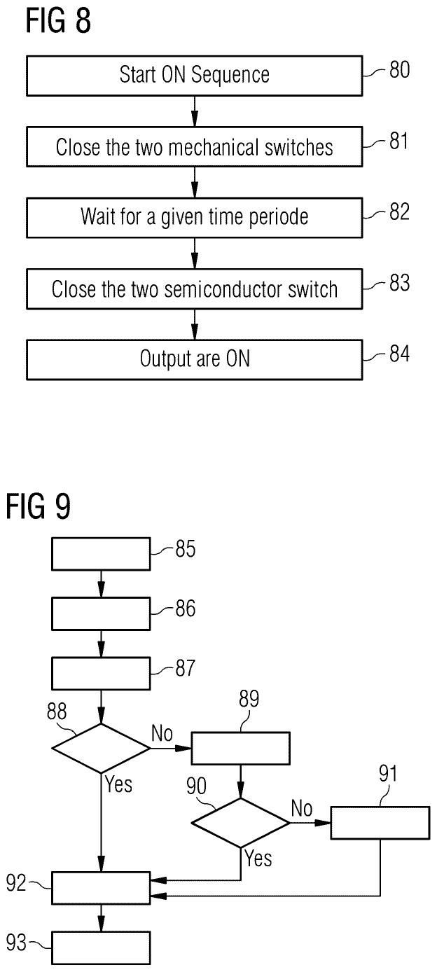

FIG. 8 is a summary of a standard ON sequence;

FIG. 9 is a summary of a standard OFF sequence; and,

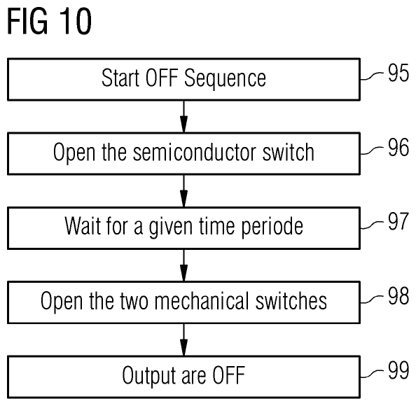

FIG. 10 is a summary of a safety OFF sequence.

FIG. 1 illustrates a first example of a system in which a subsea switching device of the present invention may be applied. The example is illustrated for two loads, although that number could be higher, for example, four loads. In a system with two loads L1, L2 located subsea 1, instead of a separate optical fibre line for the communication signals, feeding communication data to and from loads on the seabed and hardwired to each load, a topside modem 3 or device with similar functionality, located topside 2, generates a data or communications signal 6 which is then modulated, or combined in a combiner, or mixer 5, onto a power signal 7 obtained from a power source 4. Thus, a topside control unit (not shown) is able to transmit or receive communication data that has been superimposed on the power signal in this way. These two signals combined are sent via a cable or umbilical 8 to the loads L1, L2 on the seabed. Power and communication are combined in one pair of wires and split via a passive joint, or splitter, between the two loads on the seabed. These loads are typically less than 100 m apart, whereas the distance between the topside mixer and subsea joint may be several 10 s of kilometers.

FIG. 2 shows a frequency and amplitude spectrum of a combined power and communication signal with amplitude and frequency axes (not to scale). FIG. 2 illustrates how the different frequency range and amplitude of power and communications signals means that they can be combined in this way and later separated out again. A typical frequency for AC power, illustrated by line 50, is 50 Hz AC or 60 Hz AC. A typical frequency range for communication or data signals is 1 to 20 kHz, or up to 100 kHz, although higher frequencies are also possible, for example up to 1 MHz so the power and data are well separated in frequency. The communication signal 51 may be at two distinct frequencies in this frequency range, or at many frequencies distributed over the frequency range that is illustrated, or in some cases, at frequencies higher than 100 kHz. A typical amplitude of a power signal for supplying subsea loads is of the order of kilowatts, whereas a typical amplitude of a communication or data signal is of the order of milliwatts. Again, the power and data are well separated in amplitude.

This arrangement combining the power and data signals in a single pair cable allows a switching device, as shown in more detail in FIG. 3 to be used, in place of a hardwired connection, so that it is possible to switch and route powerline communication on the seabed in a large network distributed over a large area to many end-users.

A remotely operated switching device, capable of switching power and communication in one physical switch on the seabed gives the option for a large distribution system over a large area. This may be retrofitted to existing hardwired systems, of the type shown in FIG. 1, without changes to the existing loads or topside modules being required. Alternatively, the switching device of the present invention may be installed as part of a new system. Solutions using a passive two wire joint for the power cable to split the power between two loads relatively close to one another on the seabed, or to split the optical fibre communication between such loads are limited both in terms of the separation between loads and the number of loads that can be connected together without risking multiple loads being shut down when a fault occurs on just one the loads. Increasing the number of loads, increases the number of wires or cables needed. Combining data and power on the same cable and introducing switching or routing units on the seabed, the complexity of the subsea distribution, as well as the cost of the physical connection between topside and subsea, is reduced.

FIG. 3 illustrates the general layout of a subsea power and communication system 10 incorporating a subsea switching device 11 according to the present invention. The power signal 7 from the topside, or otherwise remote, power source 4 and the communication signal 6 from the topside modem 3 are combined in the combiner 5 as before and sent via the umbilical or cable 8 to the subsea switching device 11. This device switches power and communications (data) for each of loads L1 to L8 illustrated in this example. In practice, the total number of loads and the distance of one load from the subsea switching device, or from another load, is not restricted in the way that a hardwired arrangement would be, so there may be as many loads as the application requires. Each load is defined to be less than a maximum output capacity for each outlet, so that if the current drawn by the load exceeds a specified level, the switch associated with that load trips, that outlet becomes open and power and data is no longer delivered to that load. Loads may be separated from the switching unit, or from each other, by 10 s of kilometres, for example up to 40 km, or even up to 100 km. Each of the subsea switching device's switches are adapted to switch, the whole of the frequency spectrum described above, in order to distribute power and communications in existing subsea installations.

Communications to the loads use a defined communications protocol by which the loads may be allocated an address field with a unique number for each of the loads. Control from topside may use a master/slave relationship between a controller and the loads. From topside a value or a command is put up by the master or controller, with a specific destination number attached to the value or command. The load unit with that destination number either replies with a value, or with an acknowledgement that the operation it was asked to do has been completed. The master may then address another unit with some tasks. All the slave subsea loads read all communications from the master topside, but only the one with the specific address in the communication replies.

The subsea switching device design gives a significant cost saving when upgrading wires, or replacing faulty wires, in existing installations, because instead of one set of wires per two loads, it is possible to install a single set of wires from topside and a subsea switching device and connect through the subsea switching device to multiple subsea loads. This may require some additional cabling subsea, if the additional loads for the new set of wires, or cable, are at a different location, but the separation of those groups of loads is still likely to be far less than the length of wires, cable or umbilical needed from topside to those loads originally.

More detail can be seen in FIG. 4. The subsea switching device 11 itself is provided with a local power supply 20 via a power input 25 from the topside power supply 4 which is extracted via a splitter 21, or joint to generate a local supply voltage 32, e.g., at 24V DC to feed into the subsea switching unit 30. The local part of the AC topside power is transformed to a suitable voltage in a transformer (not shown), then converted to DC in the switching device, so that it is able to supply the subsea switching unit 30 at the desired local supply voltage. The remainder of the topside AC power is fed through the switching unit 30 to the loads. The subsea switching unit 30 comprises multiple switches 33, each of which provides an output 29. Those outputs 29 from each switch 33 are continuously monitored using by sensors or detectors in each switch, shown in more detail in FIG. 5, for example detecting values of voltage, current, or power, before the monitored outputs are fed into the relevant load L1 to L8. From the wires in the umbilical or cable 8, the communications signal 23 is input to an Ethernet switch 26 and then may be connected to a safety control unit 27 to provide additional functionality. The safety control unit 27 receives signals 36 from the detectors in the switch 33 and feeds communication or data signals into the switching unit 30. The safety interface 27 uses the inputs it receives from the sensors to determine whether or not a particular load should be disconnected and communicates with each switch 33 of the switching unit 30 accordingly. Alternatively, the decision may be made by a control unit within an individual switch. Using more than one control unit, each of the control units 60 being independent of the other control units, minimises single mode failures and improves functionality and reliability.

FIG. 5 shows more detail of a single switch 33 of the switching unit 30. Each switch is powered by DC lines 32, in this example at 24V DC and OV DC. Each switch may receive data communications through communication lines 23, 35, either directly from the ethernet unit 26, or via the safety unit 27. Communication to operate the semiconductor and mechanical switches and retrieval of measured data is always on the Ethernet communication 23, 34, 35. Safety shutdown is enabled by removing the 24VC supply 32 to the switch. The power 32 and communications lines 23, 35 feed into a CPU 60. Two AC powerline inputs, AC1 61 and AC2 62 provide the power to the loads, from topside, through each switch 33 of the switching unit 30. AC1 passes through an ammeter 63, semiconductor switch 64 and mechanical switch 65 to an AC output AC1 66. AC2 passes through the same ammeter 63, a second ammeter 67 and a mechanical switch 68 to an AC output 69. A voltage across a voltmeter 70 is detected at the output. Although not shown, any of voltage, current or power may be detected. The measured values from the ammeters 63, 67 or voltmeter 70 are fed into the CPU 60. The CPU provides digital control signals to the semiconductor switch 64 and to the mechanical switches 65, 68. The CPU is powered by the local power supply 20. Commands to the semiconductor switch or mechanical switches are provided on one or both of the Ethernet ports 26.

The advantage of using a single switch 33 per load (L1 to Ln) is that the switching unit can be scaled up or down according to the expected number of loads for a particular subsea deployment, as well as failure of a single switch not having any effect on the ability to switch the other loads. Although multiple loads could be controlled using shared CPUs, e.g. doubling up the AC powerline and communication lines into a single CPU and similarly doubling the outputs, so that there are still separate inputs and outputs for each load, for two loads sharing a common CPU, this is not so efficient in manufacturing terms, as two variants of the switch would need to be manufactured, one with and one without a CPU. There may be some cost reduction in only needing a single CPU for three or four loads for example, but it would be more complicated than the arrangement described.

FIG. 6 illustrates another view of an example of the full system, combining power, communications and safety features in a subsea switching device. The switching unit is as shown in FIGS. 4 and 5. When any of the multiple loads, in this example, eight loads L1 to L8, has supply voltage on its powerline outputs 66, 69, then communication on the same pair of wires is also possible. Seen from the installation topside 2, several loads subsea 1 can share the same communication medium 23, 35 and the same power link 22 on a single cable between the topside units 3, 4, 5 and the subsea units 11, L1 to L8. In the subsea part of the system the provision of the subsea switching unit 11 with existing subsea loads and topside installations means that multiple loads may be supported using only a single cable 8, without significant changes to the already installed components of the system. This makes the design particularly useful for retrofits. The topside modem 3 and power source 4, from which the communication signal 6 and power signal 7 are obtained, respectively, is provided, as before. These two signals 6, 7 are then combined by the mixer 5 in a suitable unit topside and sent via the cable or umbilical 8 to the loads L1 to L8 on the seabed. However, rather than combining power and communication on one pair of wires in the cable or umbilical 8 and splitting these via a passive joint, or splitter subsea, between only two loads on the seabed, the subsea switching device 11 carries out the splitting of the power signal 25, 32 and data signals 23, 34, 35 to each of the loads to which the power or data signals are addressed. This enables multiple loads to be served by a single pair of power and communication wires. The limitation on loads per wire has been removed.

As can be seen from the figures, an AC power source provides an input 37 to the switching unit 30 and a load takes an output 29, but the switching unit means that there can be multiple loads L1 to L 8 which each take an output 29 from that common input. Each of the outlet switches 33 of the switching unit, going to each of the loads L1 to L8 subsea carry out the functions of switching and monitoring. A local supply voltage 32 is input to the switching unit 30, which activates the switches 33 to switch the power 37 to a power outlet 29 for each load L1 to L 8. The switching unit 30 is able to measure current, differential current and voltage on the output with the sensors 63, 67, 70, as well as being configured to provide over current detection and short circuit protection. The switching unit 30 typically has the control and monitoring functions in each switch, but a safety interface 27 may be used to enable a determination of whether the measured values are such as to require one or more of the switches to be opened to disconnect a load. Alternatively, a direct external instruction, e.g. from topside, may be received that requires one or more of the switches to open and disconnect a load. The external power source 20 of the switching unit 30 in this example is 24V DC, to be able to operate the switch functionality. Typically, a microcontroller or a CPU 60 with program and data storage controls the operation of each switch.

Additional functionality of the switching unit is the provision of under and over voltage detection. Either an AC source, as shown, or a DC source, may be used as the power unit 20. Safety elements are provided by the safety unit 27, with voltage detection at the outputs 29 of each switch of the switching unit 30 and feedback 35 from the detected voltage being provided to the safety controller 27. The safety controller may then adapt the supply voltage 32 provided to the switching unit 30. The switching unit is controlled and monitored with the same control and monitoring interface 27 where current, differential current and voltage on the output 29 are processed, having been measured, as well as being configured to provide over current detection and short circuit protection. This unit 27 also monitors the detected under voltage and over voltage. The switching unit may receive a 24V DC supply from the safety controller, rather than tapping directly off the main power input 22, 32. A safety enabled voltage detector may be provided on the outlet 29 of each switch 33 of the switching unit 30 before the connection of the load. If the safety setup 27 decides to open a switch 33 of the switching unit due to a fault condition arising, then the unit 27 removes the supply voltage to the switch (yellow arrow) and the switch goes to an open position. The voltage detector on the outlet of the switch is used to verify success of the safety operation.

The switching unit 30 of the subsea switching device 11 may also be used to switch the combination of power and communication signals in the switching unit, so that communication and power may be routed with safety enabled outlets. This combination of power and communication switching only applies for the topside or remote AC power sources. The safety elements, with voltage detection at the outputs 29 of the switch and feedback 36 from the detected voltage being provided to the safety controller 27 are carried out as described above, with the safety controller providing the supply voltage 32 to the switching unit 30. The switching unit 30 is controlled and monitored, with the control and monitoring interface, where current, differential current and voltage on the output are measured, as well as being configured to provide over current detection and short circuit protection and monitoring of detected under voltage and over voltage. Each switch of the switching unit 30 may receive a 24V DC supply from the safety controller 27, if one is present, or from the local source 20, directly. A safety enabled voltage detector may be provided on the outlet of each switch of the switching unit 30 before the connection of the load. If the safety setup 27 decides to open the switch for a particular load, then the unit 27 causes the switch 33 associated with the particular load and output where the voltage has been detected goes to an open position. The voltage detector on the outlet of the switch is used to verify success of the safety operation. This is done for each of the outputs if there is deemed to be a safety issue for any of the loads, as each switch 33 switches independently of the other switches in the switching unit 30. However, if an overriding safety event occurs, for example, if an external command to stop the power to all loads is received in the safety interface, then the safety unit 27 is able to remove the local power supply to all the switches, which causes all of the switches to go into the open position and the power to all the loads is cut off simply and effectively. Thus, the safety feature may be adapted to the specific event and is able to determine whether or not the power has been successfully stopped to each or every load.

FIG. 7 is a flow diagram of the steps involved in operating a subsea power and communication system according to the present invention. A power signal is supplied 40 from a topside power source to a combiner, together with a data signal from a topside data source. The power signal and data signal are combined 41 by the combiner to generate a combined signal. This combined signal is then supplied 42 to a subsea switching device on the same electrical wires via a cable or umbilical. A local power supply in the subsea switching device is extracted 43 from the power signal of the combined signal, as well as a power element and communications element being extracted and input to the switching unit. The power and communications elements of the load specific power and communications signals are input to the switching unit 30 and pass through each switch associated with each load to their load. Current or voltage levels are detected 45 at each output of each switch and from these, the subsea control unit determines 46 whether or not the detected current or voltage levels fall outside a permitted range or threshold. If the detected levels fall outside a permitted range or threshold, then the power supply is withheld 47 from the relevant switch to terminate transmission of the power and communications signal to that load. This may also be the case, if an external instruction to cut off a load, or all loads, is received in safety grounds. If there are no triggers to cut off the loads, then the load specific power and communications signals continue to be supplied 48 to the load. The method may further comprise modulating information onto the relevant communication signal and returning the provided status information for each load and each of the relevant switches to a topside control centre.

FIG. 8 summarises a standard Off to On sequence. When the CPU of a switch receives a message to operate an outlet to a load, the switches are operated in a predefined sequence, programmed into the CPU. The ON sequence is started 80 and the two mechanical switches are closed 81. After a predetermined time period 82, the semiconductor switch is closed 83, completing the ON sequence, so that the outputs from the switching unit 30 to the loads are on. The timing parameters for these sequences may be changed by altering parameters in the CPU, but the sequence remains.

FIG. 9 summarises a standard ON to OFF sequence, when the safety feature is not invoked. The OFF sequence is started 85 and the semiconductor switch is opened 86. After waiting for a predetermined time period 87, detected currents are compared with a threshold. If the detected value is not at zero or below the predetermined threshold, then a further wait period is applied 89 and the test repeated 90. If the detected values are still not zero or below a predetermined threshold, then a warning 91 is given that the semiconductor switch may be failing and the two mechanical switches are opened 92. If at step 88 the value is determined to be a zero, or below a predetermined threshold, then the two mechanical switches are opened 92. In both cases, the outputs to the loads are now off 93. The timing parameters for these sequences may be changed by altering parameters in the CPU, but the sequence remains.

A modified version of this OFF sequence is used in the case of a safety operation. The OFF sequence is started 95 and the semiconductor switch is opened 96. After waiting for a predetermined time period 97, the two mechanical switches are opened 98 and the outputs are now off 99. For the safety operation, the sequences are hard coded and operate even if the local power supply fails, without any option to alter the timing parameters.

It should be noted that the term “comprising” does not exclude other elements or steps and “a” or “an” does not exclude a plurality. Elements described in association with different embodiments may be combined. It should also be noted that reference signs in the claims should not be construed as limiting the scope of the claims. Although the invention is illustrated and described in detail by the preferred embodiments, the invention is not limited by the examples disclosed, and other variations can be derived therefrom by a person skilled in the art without departing from the scope of the invention.

1. (canceled)

2. A subsea power and communication system comprising:
a topside power source;
a topside data source;
a modulator adapted to modulate a data signal from the data source onto a power signal from the power source;
a combined power and data cable, whereby the modulated power and data signal is transmitted on the combined cable;
a subsea switching device that receives power and data inputs through the combined cable; and
a plurality of subsea loads, wherein the subsea switching device is adapted to switch a power output and a data output to each of the plurality subsea loads independently.

3. A system according to claim 2, wherein the modulation comprises one of frequency, phase or amplitude modulation.

4. A system according to claim 2, wherein the system further comprises a subsea power splitter on the cable between the topside combiner and the subsea switching unit and a local subsea power supply unit, whereby topside power may be supplied through the power splitter to the local subsea supply unit for the subsea switching unit.

5. A system according to claim 2, wherein the local subsea supply unit further comprises a transformer or converter to supply AC or DC power respectively, to the subsea switching unit.

6. A system according to claim 2, wherein the subsea switching unit comprises at least eight outputs to subsea loads.

7. A system according to claim 2, wherein the system further comprises output current detectors at the outputs of the subsea switching unit.

8. A system according to claim 2, wherein the control unit is adapted to receive an output from each current detector or voltage detector, to compare the received output current value from each detector with a predetermined threshold value or range, and to switch the power switch of a load power output off, in the event that the received current output value falls outside a permitted tolerance of the threshold value or range.

9. A method of operating a subsea power and communication system, the method comprising:
supplying a power signal from a topside power source;
supplying a data signal from a topside data source;
combining the power signal and the data signal to generate a combined signal;
supplying the combined signal to a subsea switching device;
generating a local power supply in the subsea switching device extracted from the power signal of the combined signal;
extracting and inputting to the switching unit, a power element from the combined signal;
extracting and inputting to the switching unit, a communications element of the combined signal;
splitting the power and communications elements into load specific power and communications signals;
inputting the load specific signals at an input to each switch associated with each load; detecting current or voltage levels at each load specific output;
determining in the subsea control unit whether the detected current or voltage levels fall outside a permitted range or threshold; if not, continuing to supply the load specific power and communications signals to the load; if outside, then withholding power supply from the relevant switch to terminate transmission of the power and communications signal to that load.

10. A method according to claim 9, wherein the method further comprises modulating information onto the relevant communication signal and providing status information for each load and each of the relevant switches to a topside or remote central control.

11. The subsea power and communication system of claim 2, wherein the subsea switching device, further comprises:
a common load power input;
a local power supply input;
a plurality of load power outputs; and
a switching unit;
wherein the switching unit comprises a plurality of switches whereby the common load power input is switched between one or more of the plurality of load power outputs;
wherein the switching unit further comprises voltage sensors at each load power output, or current sensors or power sensors in each power switch; and
at least one subsea control unit;
wherein the or each control unit is adapted to receive an output from one or more of the sensors, to compare the received output value from each sensor with a predetermined threshold value or range, and to switch the power switch of a load power output off, in the event that the received output value falls outside a permitted tolerance of the threshold value or range.

12. A system according to claim 11 wherein the modulation comprises one of frequency, phase or amplitude modulation.

13. A system according to claim 11, wherein the system further comprises a subsea power splitter on the cable between the topside combiner and the subsea switching unit and a local subsea power supply unit, whereby topside power may be supplied through the power splitter to the local subsea supply unit for the subsea switching unit.

14. A system according to claim 11, wherein the local subsea supply unit further comprises a transformer or converter to supply AC or DC power respectively, to the subsea switching unit.

15. A system according to claim 11, wherein the subsea switching unit comprises at least eight outputs to subsea loads.

16. A system according to claim 11, wherein the system further comprises output current detectors at the outputs of the subsea switching unit.

17. A system according to claim 11, wherein the control unit is adapted to receive an output from each current detector or voltage detector, to compare the received output current value from each detector with a predetermined threshold value or range, and to switch the power switch of a load power output off, in the event that the received current output value falls outside a permitted tolerance of the threshold value or range.
